(19) United States
(12) Patent Application Publication
(10) Pub. No.: US 2008/0063960 A1
(43) Pub. Date: Mar. 13, 2008

(54) ELECTROPHOTOGRAPHIC PHOTORECEPTOR

(75) Inventors: Hirofumi HAYATA, Tokyo (JP); Masahiko KURACHI, Tokyo (JP); Kunihiro OGURA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/833,380

(22) Filed: Aug. 3, 2007

(30) Foreign Application Priority Data
Sep. 11, 2006 (JP) 2006-245364

(51) Int. Cl. G03G 5/04

(52) U.S. Cl. 430/58.05; 430/132; 430/66

(57) ABSTRACT

An electrophotographic photoreceptor comprising a photosensitive layer and a protective layer is disclosed. The protective layer comprises a resin which is prepared by allowing at least two acrylic or methacrylic compounds to react, and the acrylic or methacrylic compounds include a minimum acryloyl equivalent compound having minimum acryloyl equivalent and a maximum acryloyl equivalent compound having maximum acryloyl equivalent and relationships 1) and 2) are satisfied;

100≦maximum acryloyl equivalent−minimum acryloyl equivalent≦400 1)

0.1≦weight of minimum acryloyl equivalent compound/weight of maximum acryloyl equivalent compound≦1.6. 2)

This application is based on Japanese Patent Application No. 2006-245364 filed on Sep. 11, 2006, in Japanese Patent Office, the entire content of which is hereby incorporated by reference.

### FIELD

The present invention relates to an electrophotographic photoreceptor.

### BACKGROUND OF THE INVENTION

An electrophotographic receptor is required to exhibit necessary photographic speed, electric characteristics and optical characteristics according to employed electrophotographic processes. Further, in such a photoreceptor, which is, repeatedly employed many times, the surface layer of the photoreceptor, namely the layer furthest apart from the support is subjected to application of external electrical and mechanical forces such as charging, exposure, development, image transfer, or cleaning, whereby durability against those is demanded. Specifically, durability against surface abrasion and scratching due to sliding and surface degradation due to ozone and nitrogen oxides formed during charging is required. On the other hand, there are problems of adhesion of toner onto the surface layer due to repetition of development and cleaning of toner and conversion to accumulation of foreign matter. In order to overcome those, it is sought to enhance cleaning properties of the surface layer.

In order to realize characteristics demanded for the surface layer as described above, trials have been conducted in which a protective layer composed of curable resin as a main component is provided. For example, proposed is a protective layer of which resistance is controlled via addition of metal oxides as a conductive powder (refer, for example, to Patent Document 1). Main objectives of dispersion of metal oxides into the protective layer for an electrophotographic photoreceptor include minimization of an increase on the residual potential in the photoreceptor during the repeated electrophotographic process via controlling the electric resistance of the protective layer itself and enhancement of layer strength.

Further, it is shown that an appropriate resistance value of the protective layer for electrophotographic photoreceptors is 10¹⁰-10¹⁵ Ω·cm. Further, the surface resistance of the photoreceptors decreases due to adhesion of corona products such as ozone or nitrogen oxides generated during repeated charging, particularly at high humidity, whereby problems such as image smearing occurs. Further, releasing properties of binding resin to realize longer life and durability against abrasion and scratches due to sliding have not been sufficient. Subsequently, at present, a protective layer, which exhibits targeted electrophotographic characteristics, has not been realized.

(Patent Document 1) Japanese Patent Publication Open to Public Inspection (hereinafter referred to as JP-A) No. 57-30846.

### SUMMARY OF THE INVENTION

An object of the present invention is to provide an electrophotographic photoreceptor which exhibits excellent film strength, minimizes abrasion amount and forms sharp images under high temperature and high humidity.

The above object of the present invention is achieved via the following embodiments.
1. An electrophotographic photoreceptor comprising an electrically conductive support having thereon a photosensitive layer and a protective layer in that order,

wherein the protective layer comprises a resin which is prepared by allowing at least two acrylic or methacrylic compounds to react with one another.

Among the acrylic or methacrylic compounds, one is a minimum acryloyl equivalent compound having minimum acryloyl equivalent and the other is a maximum acryloyl equivalent compound having maximum acryloyl equivalent, the minimum acryloyl equivalent being different from the maximum acryloyl equivalent.

The relationships 1) and 2) are satisfied;

100≦maximum acryloyl equivalent−minimum acryloyl equivalent≦400 1)

0.1≦weight of minimum acryloyl equivalent compound/weight of maximum acryloyl equivalent compound≦1.6. 2)

The acryloyl equivalent of an acrylic or methacrylic compound is molecular weight of the acrylic or methacrylic compound/number of acryloyl or acryloyl groups of the acrylic or methacrylic compound.

The relationships 2′) is satisfied in the preferable embodiment.

0.1≦weight of minimum acryloyl equivalent compound/weight of maximum acryloyl equivalent compound≦0.5. 2′)

The number of acryloyl groups of the minimum acryloyl equivalent compound is preferably at least 4.

The number of acryloyl groups of the aforesaid maximum acryloyl equivalent compound is preferably 2.

The electrophotographic photoreceptor may prepared by a method comprising steps of forming a photosensitive layer on an electrically conductive support, coating a coating composition containing at least two acrylic or methacrylic compounds dissolved in a solvent, exposing coated composition to actinic radiation, in which one of the acrylic or methacrylic compounds is a minimum acryloyl equivalent compound having a minimum acryloyl equivalent and another of the acrylic or methacrylic compounds is a maximum acryloyl equivalent compound having a maximum acryloyl equivalent, the minimum acryloyl equivalent being different from the maximum acryloyl equivalent, and

relationships 1) and 2) are satisfied;

100≦maximum acryloyl equivalent−minimum acryloyl equivalent≦400 1)

0.1≦weight of minimum acryloyl equivalent compound/weight of maximum acryloyl equivalent compound≦1.6, 2)

wherein acryloyl equivalent of an acrylic or methacrylic compound is

(molecular weight of the acrylic or methacrylic compound)/(number of acryloyl or acryloyl groups of the acrylic or methacrylic compound).

The other embodiments are described.
1. An electrophotographic photoreceptor which comprises an electrically conductive support having thereon a photosensitive layer and a protective layer, which are multi-layered in this order, wherein the aforesaid protective layer comprises a resin which is prepared by allowing at least two (meth)acrylic compounds, which differ in acryloyl equivalent, to react with one another, followed by curing reaction, and in the aforesaid at least two (meth)acrylic compounds which differ in acryloyl equivalent, relationships 1) and 2) described below, are satisfied.

100≦maximum acryloyl equivalent−minimum acryloyl equivalent≦400 1)

0.1≦weight of minimum acryloyl equivalent compound/weight of maximum acryloyl equivalent compound≦1.6 2)
2. The electrophotographic photoreceptor, described in 1. above, wherein in aforesaid relationships 1) and 2), 2) is 0.1≦weight of minimum acryloyl equivalent compound/weight of maximum acryloyl equivalent compound≦0.5.
3. The electrophotographic photoreceptor, described in 1. or 2. above, wherein the number of acryloyl groups of the aforesaid minimum acryloyl equivalent compound is at least 4.
4. The electrophotographic photoreceptor, described in any one of 1., 2. or 3. above, wherein the number of acryloyl groups of the aforesaid maximum acryloyl equivalent compound is 2.

### DESCRIPTION OH THE PREFERRED EMBODIMENTS

According to the present invention, it was possible to provide an electrophotographic photoreceptor which exhibits excellent film strength, minimizes abrasion amount and forms sharp images under high temperature and high humidity.

The present invention will now be detailed.

In the present invention, mechanical strength and printing life of electrophotographic photoreceptors (hereinafter also referred to simply as photoreceptors) are enhanced via the protective layer formed thereon. The aforesaid protective layer comprises a resin which is prepared by reacting photocurable acrylic or methacrylic compounds, which are abbreviated as “(meth)acrylic compounds”. Examples of such (meth)acrylic compounds of this invention will be listed. (Meth)acrylic compounds refer to compounds having either an acryloyl group, (CH₂═CHCO—) or a methacryloyl group, (CH₂═CCH₃CO—). Further, number of Ac groups (number of acryloyl groups), as described herein, refers to the number of acryloyl or methacryloyl groups.

| Exemplified | | Number of |
|---|---|---|
| Compound No. | Structural Formula | Ac groups |
| (1) | 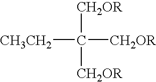 | 3 |
| (2) | 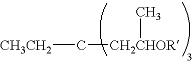 | 3 |
| (3) | 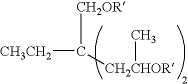 | 3 |
| (4) | 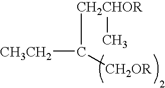 | 3 |
| (5) | 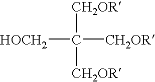 | 3 |
| (6) | 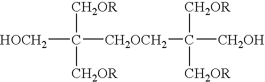 | 4 |
| (7) | 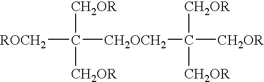 | 6 |
| (8) | 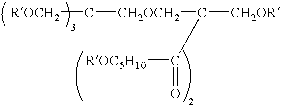 | 6 |
| (9) | 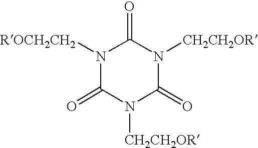 | 3 |
| (10) | 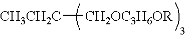 | 3 |
| (11) | 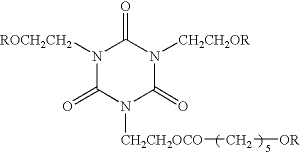 | 3 |
| (12) | 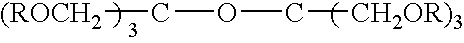 | 6 |
| (13) | 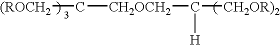 | 5 |
| (14) | 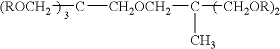 | 5 |
| (15) | 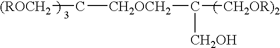 | 5 |
| (16) | 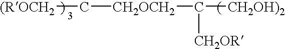 | 4 |
| (17) | 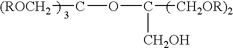 | 5 |
| (18) | 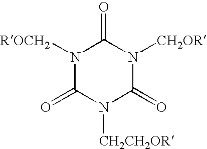 | 3 |
| (19) | 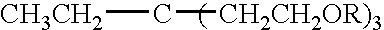 | 3 |
| (20) | 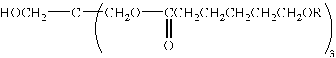 | 3 |
| (21) | 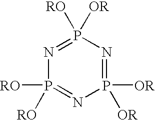 | 6 |
| (22) | 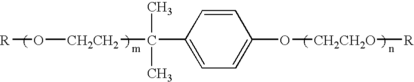 | 2 |
| (23) | 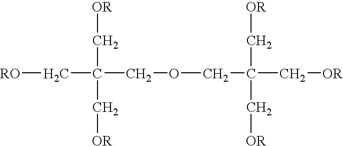 | 6 |
| (24) | 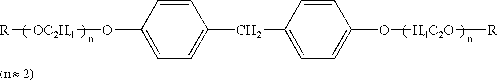 | 2 |
| (25) | 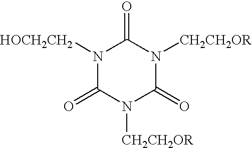 | 2 |
| (26) | 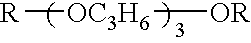 | 2 |
| (27) | 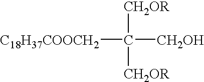 | 2 |
| (28) | 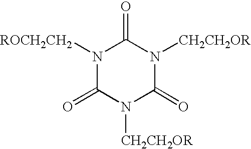 | 3 |
| (29) | 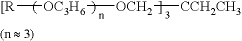 | 3 |
| (30) | 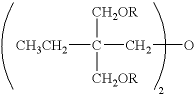 | 4 |
| (31) | 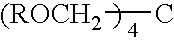 | 4 |
| (32) | RO—C₆H₁₂—OR | 2 |
| (33) | 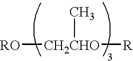 | 2 |
| (34) | 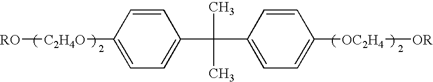 | 2 |
| (35) | 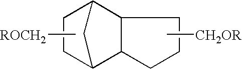 | 2 |
| (36) | 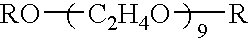 | 2 |
| (37) | 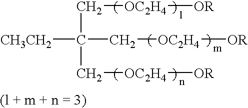 | 3 |
| (38) | 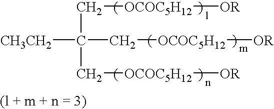 | 3 |

In the above formulae, R and R′ are each as follows:

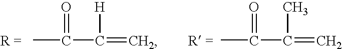

KAYARAD MANDA (being a bifunctional acryl monomer having a molecular weight of 312, produced by Nippon Kayaku Co., Ltd.): C-1

Further employed by be various reactive oligomers. Examples of usable ones include epoxyacrylate oligomer, urethane acrylate oligomer, polyester acrylate oligomer, and unsaturated polyester resins.

| Exemplified | | Number of |
|---|---|---|
| Compound No. | Structural Formula | Ac groups |
| (39) | 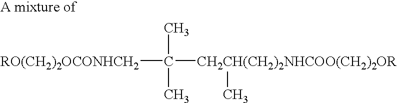 | 2 |
| | and | |
| | 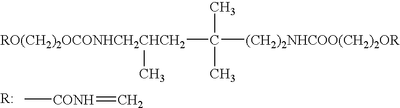 | 2 |
| (40) | (ROCH₂)₃CCH₂OCONH(CH₂)₆NHCOOCH₂C(CH₂OR)₃ | 2 |
| | R: —COCH═CH₂ | |

Exemplified Compound (39) is E4853, produced by Daicel-Cytec Co., Ltd.

KAYARAD DPCA 120 (being hexaacrylate of a dipentaerythritol derivative at a molecular weight of 1,947, produced by Nippon Kayaku Co., Ltd.): B-2

E8402 (being bifunctional urethane acrylate at a molecular weight of 1,000, produced by Daicel-Cytec Co., Ltd.): B-3

The photoreceptor of this invention comprises an electrically conductive support having thereon a photosensitive layer and a protective layer. The protective layer contains a resin which is prepared by allowing at least two (meth)acrylic compounds to react and cure, and the compounds have different acryloyl equivalent from each other. One is a compound having a minimum acryloyl equivalent, that is called minimum acryloyl equivalent compound, and the other is a compound having a maximum acryloyl equivalent, that is called maximum acryloyl equivalent compound. The acryloyl equivalent of an acrylic or methacrylic compound is ratio of molecular weight to number of acryloyl or acryloyl groups of the acrylic or methacrylic compound, that is, (molecular weight)/(number of acryloyl or acryloyl groups) of the acrylic or methacrylic compound. The (meth)acrylic compounds satisfy the relationships 1) and 2).

Further, it is more preferable that 2) is 0.1≦weight of minimum acryloyl equivalent compound/weight of maximum acryloyl equivalent compound≦0.5. Still further, it is preferable that the number of acryloyl groups of the minimum acryloyl equivalent compound is at least 4, while it is further preferable that the number of acryloyl groups of the maximum acryloyl equivalent compound is 2.

The term “an acryloyl group” includes an acryloyl group and a methacryloyl group hereafter.

Acryloyl group, as described herein, includes the group represented by R or R′, while acryloyl equivalent is defined as molecular weight of acrylic compound/number of acryloyl groups. In the case of oligomer, the molecular weight refers to the average molecular weight, while the number of the acryloyl groups is the number of the acryloyl groups in the oligomer of a maximum molecular weight.

The inventors of the present invention discovered that when the residual amount of the non-reacted acryloyl group in the cured resin, unsharp image blurring is formed in an ambience of high temperature and high humidity. On the other hand, when to decrease the amount of acryloyl group in the film, resins are formed employing a reactive curable materials having the smaller number of acryloyl groups, film strength becomes insufficient, whereby during actual image printing, the amount of the scraped photoreceptor increases.

The inventors of the present invention discovered that by employing a protective layer which is prepared employing (meth)acrylic compounds which satisfy the above two relationships, it was possible to simultaneously overcome the problem of insufficient film strength and the problem of image blurring at high temperature and high humidity.

The acryloyl equivalent difference and the amount ratio of (meth)acrylic compounds having different acryloyl equivalent, will now be described.

An object of the present invention is to realize compatibility of high quality of sufficient film strength and sharp images. When attention is paid to film strength, it is possible to prepare many crosslinking points carrying film which is hard and is not easily scraped when the protective layer is formed in such a manner that materials exhibiting small acryloyl equivalent as possible, namely only multi-functional materials, undergo reaction and curing.

However, it is assumed that functional groups in the film result in a state of markedly large steric hindrance, and are fixed during an early period to make it impossible to realize positional relationships among functional groups for reaction, whereby many unreacted acryloyl groups remain in the protective layer. It is considered that the remaining acryloyl groups are affected by the ambience of high temperature and high humidity, as well as acidic gases to result in image blurring.

On the other hand, in order to form sharp images, compounds which exhibit as large acryloyl equivalent as possible are advantageously employed, while it is not possible to realize the targeted enhancement of film strength. In the present invention, it is assumed that reaction rate in the film is enhanced in such a way that polyfunctional compounds of smaller acryloyl equivalent are employed at a crosslinking branch point, and between the above points, a mixture, which is prepared by mixing at an appropriate ratio, low functional compounds of large acryloyl equivalent, which exhibit a relatively large degree of freedom in terms of structure, undergoes reaction.

By controlling the acryloyl equivalent and the amount ratio within the specified value as described, residual acryloyl groups were successfully and significantly decreased, and targeted film strength and sharp images were simultaneously realized. Namely, it was discovered that targeted film strength and sharp images were simultaneously realized by employing at least two (meth)acrylic compounds, which differed in acryloyl equivalent, so that these satisfy above relationships 1) and 2).

The other resins may be blended in addition to at least two (meth)acrylic compounds having different acryloyl equivalent each other in the present invention. Examples of the resins include polyester, polycarbonate, polyurethane, acrylic resins, epoxy resins, silicone resins, alkyd resins, or vinyl chloride-vinyl acetate copolymers.

A polymerization initiator may be employed for curing reaction of (meth)acrylic compounds. The added amount of the initiators is preferably 0.1-20% with respect to the total weight of the (meth)acrylic compounds, but is more preferably 0.5-10%. Usable initiators include photopolymerization initiators and thermal polymerization initiators. Further, both may be employed in combination.

The protective layer of the present invention is formed in such a manner that at least two (meth)acrylic compounds, which differ in acryloyl equivalent, are dissolved in solvents and the resulting liquid coating composition is coated followed by undergoing reaction. The protective layer may also be formed in such a manner that a liquid coating composition in which, other than the above (meth)acrylic compounds, if desired, polymerization initiators, fillers, lubricant particles and antioxidants may be incorporated, and is coated followed by undergoing reaction. A preferred protective layer is formed in such a manner that a liquid coating composition into which the above (meth)acrylic compounds and fillers (such as minute electrically conductive metal oxide particles) are dispersed, is coated, followed by undergoing reaction.

When the (meth)acrylic compounds of the present invention undergo reaction, methods are employed which include a method in which reaction undergoes via electron cleavage, and a method in which radical polymerization initiators are added and reaction is performed via radiation and heat. Employed as the polymerization initiators may be any of the photopolymerization initiators and thermal polymerization initiators. Further, a photopolymerization initiator and a thermal polymerization initiator may be employed in combination.

Polymerization initiators include acetophenone based or ketal based photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morphlinophenyl)butanone-1,2-hydroxy-2-methyl-1-phenylpropane-1-one, 2-methyl-2-morpholino(4-methylthiophenyl)propane-1-one, or 1-phenyl-1,2-propanedione-2-(o-ethoxycarbonyl)oxime; benzoinether based photopolymerization initiators such as benzoin, benzoin methyl ether, benzoin isobutyl ether, or benzoin isopropyl ether; benzophenone based photopolymerization initiators such as benzophenone, 4-hydroxybenzophenone, methyl o-benzoyl benzoate, 2-benzoylnaphthalene, 4-benzoylbiphenyl, 4-benzoyl phenyl ether, acrylated benzophenone, or 1,4-benzoylbenzene; and thioxanthone based photopolymerization initiators such as 2-isopropylthioxanthone, 2-chlorothioxanthone, 2,4-dimethylthioxanthone, 2,4-diethylthioxanthone, or 2,4-dichlorothioxanthone.

Other photopolymerization initiators include ethylanthraquinone, 2,4,6-trimethylbenzoyldiphenylphosphine oxide, 2,4,6-trimethylbenzoylphenylethoxyphosphine oxide, bis(2,4,6-trimethylbenzoyl)phenylphosphine oxide, bis(2,4-dimethoxybenzoyl)-2,4,4-trimethylpentylphosphine oxide, methylphenyl glyoxyester, 9,10-phenantholene, acridine based compounds, triazine based compounds, and imidazole based compounds. Further, compounds which exhibit photopolymerization enhancing effects may be employed individually or in combination with the above photopolymerization initiators. Examples of such include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

These polymerization initiators may be employed individually or in combinations of at least two types. The content of polymerization initiators is commonly 0.1-20 parts by weight with respect to 100 parts by weight of the (meth)acrylic compounds, and is preferably 0.5-10 parts by weight.

Further, in order to enhance film strength and to control resistance, incorporated may be various fillers. Usable fillers include various metal oxides such as silica, alumina, zinc oxide, titanium oxide, tin oxide, antimony oxide, indium oxide, or bismuth oxide, as well as ultra-fine particles such as tin-doped indium oxide, antimony-doped tin oxide and zirconium oxide. These metal oxides may be employed individually or in combinations of at least two types. When employed in combinations, states such as solid solution or fusion may be acceptable.

The diameter of filler particles is preferably 1-300 nm in terms of number average primary particle diameter, but is most preferably 3-100 nm. The ratio of fillers in the protective layer is preferably 1-100 parts by weight with respect to 100 parts by weight of the binder resin, but is most preferably 10-80 parts by weight.

In the protective layer employed in the present invention, to enhance dispersibility of minute electrically conductive metal oxide particles and to enhance smoothness, various additives may be incorporated. Specifically, with regard to enhancement of dispersibility, it is very effective to perform a surface treatment employing minute metal oxide particles. Surface treatments include treatments with various inorganic compounds, and treatments with silicon compounds, fluorine-containing silane coupling agents, fluorine-modified silicone oils, fluorine-containing surface active agents, and fluorine-based graft polymers.

Various lubricating particles may be incorporated into the protective layer employed in the present invention. For example, fluorine containing resin particles may be incorporated. Fluorine containing resin particles may be composed of tetrafluoroethylene resins, trifluoromonochloroethylene resins, hexafluoromonochloroethylene propylene resins, vinyl fluoride resins, vinylidene fluoride resins, or difluorodichloroethylene resins, and copolymers thereof. It is preferable that they are employed individually or in combinations at least two types upon appropriately selected. Specifically preferred are tetrafluoroethylene resins and vinylidene fluoride resins. The ratio of fluorine containing resin particles in the protective layer is in the range of 5-70% by weight, but is more preferably in the range of 10-60% by weight. The diameter of lubricating particles is preferably 0.01-1 μm in terms of average primary particle diameter, but is most preferably 0.05-0.5 μm. The appropriate molecular weight of resins and the diameter of particles may be selected, and but not particularly limited.

Usable means to disperse fillers and lubricating particles include, but are not limited to, an ultrasonic homogenizer, a ball mill, a sand grinder, and a homomixer.

In the present invention, in order to enhance weather resistance, incorporated into the above protective layer may be additives such as antioxidants. Antioxidants which are the same as those incorporated in the charge transporting layer may be selected.

Solvents to form the protective layer include, but are not limited to, methanol, ethanol, n-propyl alcohol, isopropyl alcohol, n-butanol, t-butanol, sec-butanol, benzyl alcohol, toluene, xylene, methylene chloride, methyl ethyl ketone, cyclohexane, ethyl acetate, butyl acetate, methyl cellosolve, ethyl cellosolve, tetrahydrofuran, 1-dioxane, 1,3-dioxolan, pyrimidine, and diethylamine.

It is preferable that the protective layer of the present invention, after coating, is subjected to natural drying or heat drying, followed by reaction via exposure to actinic radiation.

Employable coating methods include those known in the art, such as a dip coating method, a spray coating method, a spinner coating method, a bead coating method, a blade coating method, a beam coating method, or a slide hopper method, which are described as a coating method for the interlayer and the photosensitive layer.

It is preferable that the coated layer of the photoreceptor of the present invention is cured while forming cured resins in such as manner that actinic radiation is exposed to the coating to generate radicals followed by polymerization and curing is performed by formation of crosslinking bonds via inter- and intramolecular crosslinking reactions. Ultraviolet radiation and electron beams are particularly preferred as the above actinic radiation.

Usable ultraviolet radiation sources are not particularly limited as long as they generate appropriate ultraviolet radiation. For example, employed may be low pressure mercury lamps, medium pressure mercury lamps, high pressure mercury lamps, ultra-high pressure mercury lamps, carbon arc lamps, metal halide lamps, and xenon lamps. Exposure conditions differ depending on each type of lamp. The exposure amount of actinic radiation is commonly 5-500 mJ/cm², but is preferably 5-100 mJ/cm². Power consumption of the above lamps is preferably 0.1-5 kw, but is most preferably 0.5-3 kw.

In regard to electron beams, electron beam exposure devices are not particularly limited. Commonly employed as an electron beam accelerator for electron beam exposure is one of the curtain beam system, which is relatively low cost, and results in high output. Acceleration voltage during exposure to electron beams is preferably 100-300 kV, while the absorption dose is preferably 0.5-10 Mrad.

Exposure period to reach the exposure amount of necessary active radiation is preferably 0.1 second-10 minutes, but in view of curing efficiency of (meth)acrylic compounds and operating efficiency, is more preferably 0.1 second to 5 minutes.

Ultraviolet radiation is particularly preferred as actinic radiation due to ease of use.

The photoreceptor of the present invention may be dried prior to and after exposure of actinic gradation, and during exposure of actinic radiation, and timing to carry out drying may be appropriately selected depending on these combinations.

Appropriate drying conditions are selected depending on the type of solvents and film thickness. Drying temperature is preferably between room temperature—180° C., but is most preferably 80-140° C., while drying period is preferably 1-200 minutes, but is most preferably 5-100 minutes.

A protective layer is preferably formed in such a manner that minute electrically conductive metal oxide particles are dispersed into the above binder resins, and the resulting dispersion is coated, followed by curing. The thickness of the protective layer is preferably 0.2-10 μm, but is more preferably 0.5-6 μm.

A photosensitive layer will now be described.

The photoreceptor of the present invention comprises an electrically conductive support having thereon at least a photosensitive layer and a protective layer. The layer configurations are not particularly limited and include the following specific ones:

1) Provided on an electrically conductive support are charge generating and charge transporting layers as a photosensitive layer, and a protective layer in the stated order.

2) Provided on an electrically conductive support are a single layer incorporating charge transporting and charge generating materials as a photosensitive layer, and a protective layer in the stated order.

3) Provided on an electrically conductive support are an interlayer, charge generating and charge transporting layers as a photosensitive layer, and a protective layer in the stated order.

4) Provided on an electrically conductive support are an interlayer, a single layer incorporating charge transporting and charge generating materials as a photosensitive layer, and a protective layer in the stated order.

The photoreceptor of the present invention may be composed of any of the above layer configurations, but of these, one is preferred which is produced via providing, on an electrically conductive support, an interlayer, a charge generating layer, a charge transporting layer, and a protective layer.

It is possible to coat these interlayer, photosensitive layer and protective layer, employing coating methods such as a dip coating method, a spray coating method, a spinner coating method, a bead coating method, a blade coating method, a beam coating method, or a slide hopper coating method.

### (Electrically Conductive Supports)

Supports employed in the present invention are not particularly limited as long as they are electrically conductive, and examples include those which are produced by molding metals such as aluminum, copper, chromium, nickel, zinc, or stainless steel into a drum or a sheet, by laminating metal foil composed of aluminum or copper onto a plastic film, or by depositing aluminum, indium oxide, or tin oxide onto a plastic film, as well as metal, plastic film and paper provided with an electrically conductive layer which is prepared via coating electrically conductive materials individually or in combination with binder resins.

### (Interlayer)

In the present invention, it is possible to provide, between the electrically conductive layer and the photosensitive layer, a sublayer exhibiting a barrier function and an adhesion function. It is possible to form the sublayer in such a way that binders, such as casein, polyvinyl alcohol, nitrocellulose, ethylene-acrylic acid copolymer, polyamide, polyurethane, or gelatin, are dissolved in solvents, followed by application of the resulting composition via dip coasting. Of these, preferred is a polyamide which is soluble in alcohol.

Further, to control resistance of the interlayer, various minute electrically conductive particles and metal oxides may be incorporated. Examples include various metal oxides such as alumina, zinc oxide, titanium oxide, tin oxide, antimony oxide, indium oxide, or bismuth oxide. It is possible to employ ultra-fine particles such as indium oxide doped with tin, as well as tin oxide and zirconium oxide doped with antimony. These metal oxides may be employed individually or in combinations of at least two types. When employed in combinations of at least two types, states such as solid solution or fusion are acceptable. The average diameter of the above metal oxide particles is preferably at most 0.3 μm, but is more preferably at most 0.1 μm.

Preferred solvents employed to form the interlayer are those which efficiently disperse inorganic particles and dissolve polyamide resins. Specifically preferred are alcohols having 2-4 carbon atoms, such as ethanol, n-propyl alcohol, isopropyl alcohol, n-butanol, t-butanol, or sec-butanol, since they exhibit high solubility of polyamide resins and excellent coating properties. Further listed as solvent aids which result in the targeted effects in combination with the above solvents to enhance retention properties and particle dispersibility, are methanol, benzyl alcohol, toluene, methylene chloride, cyclohexane, and tetrahydrofuran.

Concentration of binder resins is appropriately selected to match to the thickness of the interlayer and the production rate. The mixing ratio of inorganic particles to binder resins during dispersing of inorganic particles is preferably 20-400 parts by weight with respect to 100 parts by weight of the binder resins, but is more preferably 50-200 parts.

Employed as inorganic particle dispensing means may be an ultrasonic homogenizer, a ball mill, a sand grinder, and a homomixer, however the means are not limited thereto.

Appropriate drying methods of the interlayer may be selected depending on the type of solvents and the film thickness, but heat drying is preferred.

The thickness of the interlayer is preferably 0.1-15 μm, but is more preferably 0.3-10 μm.

The charge generating layer employed in the present invention comprises a charge generating material and binder resin. It is preferable that the above charge generating layer is formed in such a way that charge generating material is dispersed into a binder resin solution and the resulting dispersion is coated.

### (Charge Generating Layer)

Examples of preferably employed binders of the charge generating layer include polystyrene resins, polyethylene resins, polypropylene resins, acrylic resins, methacrylic resins, vinyl chloride resins, vinyl acetate resins, polyvinyl butyral resins, epoxy resins, polyurethane resins, phenol resins, polyester resins, alkyd resins, polycarbonate resins, silicone resins, and melamine resins, as well as copolymer resins incorporating at least two of the above resins (for example, vinyl chloride-vinyl acetate copolymer resins and vinyl chloride-vinyl acetate-maleic anhydride copolymer resins) and polyvinyl carbazole resins.

It is preferable to form the charge generating layer as follows. Charge generating materials are dispersed, via a homogenizer, into a solution prepared by dissolving binder resins into solvents, whereby a liquid coating composition is prepared. The resulting liquid coating composition is coated via a coater to result in a predetermined thickness and the coating is then dried.

Preferably employed solvents which dissolve binders employed in the charge generating layer for coating include toluene, xylene, methylene chloride, 1,2-dichloroethane, methyl ethyl ketone, cyclohexane, ethyl acetate, butyl acetate, methanol, ethanol, propanol, butanol methyl cellosolve, ethyl cellosolve, tetrahydrofuran, 1-dioxane, 1,3-dioxyolane, pyridine and diethylamine.

Employed as dispersing means of charge generating materials may be an ultrasonic homogenizer, a ball mill. a sand grinder, and a homomixer.

The ratio of charge generating materials to binder resins is preferably 20-600 parts by weight with respect to 100 parts by weight of the binder resins, and is more preferably 50-500 parts. The thickness of the charge generating layer, though varying depending on targeted characteristics of charge generating materials and binder resins, as well as on the mixed ratio of resins, is preferably at most 5 μm, is more preferably 0.01-5 μm, but is still more preferably 0.05-3 μm. Meanwhile, it is possible to minimize image problems via filtering the charge generating layer liquid coating composition prior to coating to remove foreign matter and coagulants. It is also possible to carry out formation via vacuum deposition of the above pigments.

### (Charge Transporting Layer)

A charge transporting layer employed in the photoreceptor of the present invention comprises charge transporting materials and binder resins, and is formed in such a manner that the above charge transporting materials are dissolved in the above binder resins and the resulting mixture is coated. Examples of charge transporting materials include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triarylamine derivatives, phenylenediamine derivatives, stilbene derivatives, poly-N-vinylcarbazole, poly-1-vinylpyrene, and poly-9-vinylanthracene. At least two of them are blended and then employed.

Examples of binders for the charge transporting layer include polycarbonate resins, polyacrylate resins, polyester resins, polystyrene resins, styrene-acrylonitrile copolymer resins, polymethacrylate resins, and styrene-methacrylate copolymer resins, of which polycarbonate is preferred. Further, in terms of cracking resistance, abrasion resistance and charging characteristics, preferred are EPA, BPZ, dimethyl EPA, and BPA-dimethyl EPA copolymers.

It is preferable to form the charge transporting layer in such a manner that binder resins and charge transporting materials are dissolved in solvents and the resulting liquid coating composition is applied onto a substrate to result in uniform layer thickness, followed by drying the coating.

Examples of solvents employed to dissolve the above binder resins and charge transporting materials include, but are not limited to, toluene, xylene, methylene chloride, 1,2-dichloroethane, methyl ethyl ketone, cyclohexanone, ethyl acetate, butyl acetate, ethanol, propanol, butanol, tetrahydrofuran, 1,4-dioxane, 1,3-dioxolan, pyridine, and diethylamine.

The mixing ratio of charge transporting layer to binder resins is preferably 10-500 parts by weight with respect to 100 parts by weight of the binder resins, but is more preferably 20-100 parts by weight.

Antioxidants, electronic conductors, and stabilizers may be incorporated in the charge transporting layer. Preferably employed as the above antioxidants may be those described in JP-A No. 2000-305291, while preferably employed as the above electronic conductors may be those described in JP-A Nos. 50-137543, 58-76483 and so on.

The thickness of the charge transporting layer, though variable depending on characteristics of charge transporting materials and binder resins as well as their mixing ratio, is preferably 5-40 μm, but is more preferably 10-30 μm.

The electrophotographic photoreceptor of the present invention is not only applied to electrophotographic copiers but also widely used in electrophotography applied fields such as laser-beam printers, CRT printers, LED printers, liquid crystal printers or laser plate production.

### EXAMPLES

The present invention will now be detailed with reference to examples, however the present invention is not limited thereto.

### Example 1

### (Preparation of Electrophotographic Photoreceptor)

### (Surface Treatment of Particles: Preparation of Particles 1)

Dissolved and dispersed in 10 parts of ethanol/n-propyl alcohol/THF (at a volume ratio of 45:20:35) was 0.2 part of methyl hydrogen polysiloxane. After adding, to the above mixed solvents, 3.5 parts of rutile type titanium oxide (at a number average diameter of the primary particle of 35 nm and 5% primary surface treatment via alumina), stirring was carried out for one hour and surface treatment (being a secondary surface treatment) was carried out. After separation from the solvents, heat drying was carried out, whereby Surface Treated Particles 1 were prepared.

### (Interlayer)

While stirring, one part of binder resin (N-1) was dissolved in 20 parts of ethanol/n-propyl alcohol/THF (at a volume ration of 45:20:35). Thereafter, the resulting solution was blended with 4.2 parts of Surface Treated Particles 1 and the resulting mixture was dispersed employing a bead mill. The above dispersion was carried out under such conditions that the average diameter of beads was 0.1-0.5 mm, the peripheral rate was set at 4 m/second, and the retention period was three hours, whereby an interlayer liquid coating composition was prepared. After filtration via a 5 μm filter, the resulting interlayer coating composition was applied onto a washed cylindrical aluminum substrate (which had been subjected to cutting work to result in 10-point surface roughness Rz of 0.81 μm, specified in JIS B 0601), employing a dip coating method, whereby an approximately 2 μm thick dried interlayer was formed.

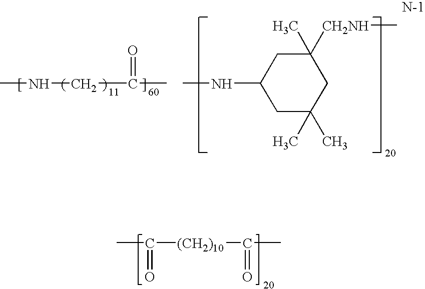

### (Charge Generating Layer)

The following components were blended and then dispersed employing a sand mill homogenizer, whereby a charge generating layer liquid coating composition was prepared. The resulting liquid coating composition was applied onto the above interlayer employing a dip coating method, whereby a 0.3 μm dried charge generating layer was formed.

| | |
|---|---|
| Y-titanylphthalocyanine (being Titanylphthalocyanine | 20 parts |
| pigment, having a maximum diffraction peak at | |
| Bragg angle (2θ ± 0.2°) in an X-ray | |
| diffraction spectra by Cu-Kα | |
| characteristic X-ray | |
| Polyvinyl butyral (BX-1, produced by Sekisui Chemical | 10 parts |
| Co., Ltd.) | |
| Methyl ethyl ketone | 700 parts |
| Cyclohexanone | 300 parts |

### (Charge Transporting Layer)

The following components were blended and dissolved, whereby a charge transporting layer liquid coating composition was prepared. The resulting coating liquid was applied onto the above charge generating layer employing a dip coating method, and then dried at 120° C. for 70 minutes to form a 20 μm dried charge transporting layer.

| | |
|---|---|
| Charge transporting layer (having the following structure) | 50 parts |
| Polycarbonate resin “IUPILON-Z300” (produced by | 100 parts |
| Mitsubishi Gas Chemical Company INC.) | |
| Antioxidant 2,6-di-t-butyl-4-methylphenol | 8 parts |
| Tetrahydrofuran/toluene (volume ratio 8/2) | 750 parts |
| Charge transporting material | |
| 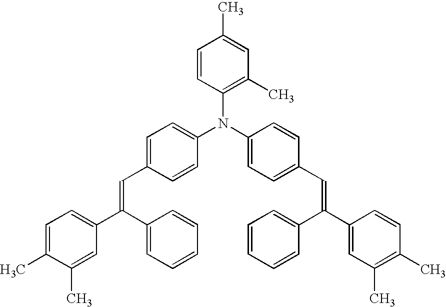 | |

### (Protective Layer)

### <Preparation of Protective Layer Liquid Coating Composition>

Curable Materials A, B, and C described in Table 1 at the volume ratio (A/B/C) described in Table 1 were dissolved in a mixture of 5.1 parts of 1-propanol and 2.4 parts of methyl isobutyl ketone. Further, 0.6 part of minute fluororesin particles of a particle diameter of approximately 300 nm and 0.8 part of minute anatase type titanium oxide particles (of a particle diameter of approximately 6 nm and 20% by weight of surface treatment methyl hydrogen silicone oil) were added, and the resulting mixture was dispersed for 15 minutes employing an ultrasonic homogenizer, whereby a dispersion incorporating curable materials, minute fluororesin particles, and minute titanium oxide particles was prepared. Added to the above dispersion was 0.05 part of radical polymerization initiator (Compound D), whereby a protective layer liquid coating composition was prepared.

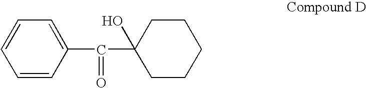

### <Coating and Curing of Protective Layer>

The above protective layer liquid coating composition was applied onto the aforesaid photosensitive layer via dip coating. After application, the resulting coating was dried at room temperature for 10 minutes. Thereafter, a photosensitive drum was positioned 100 mm apart from a 2 kw high pressure mercury lamp, and while rotating the above photosensitive drum, the protective layer was cured over three minutes via exposure to radiation. After curing, drying was carried out at a heating temperature of 120° C. for 30 minutes, whereby an electrophotographic photoreceptor provided with a protective layer was produced. In Tables 1 and 2, Ac equivalent represents acryloyl equivalent and weight ratio represents weight of minimum acryloyl equivalent compound/weight of maximum acryloyl equivalent compound, while Ac based compound refers to an acrylic compound. Ac equivalent difference refers to the value of maximum acryloyl equivalent−minimum acryloyl equivalent.

TABLE 1

| | Curing Material A | | | | Curing Material B | | | | Curing Material C | | | |
|---|---|---|---|---|---|---|---|---|---|---|---|---|
| | | Molecular | Number of | | (Meth)acrylic | Molecular | Number of | | (Meth)acrylic | Molecular | Number of | |
| *1 | (Meth)acrylic | Weight | Ac groups | *2 | Compound | Weight | Ac groups | *2 | Compound | Weight | Ac groups | *2 |
| 1 | 30 | 466 | 4 | 116.5 | 39 | 442 | 2 | 221 | — | — | — | — |
| 2 | 30 | 466 | 4 | 116.5 | 39 | 442 | 2 | 221 | — | — | — | — |
| 3 | 30 | 466 | 4 | 116.5 | 39 | 442 | 2 | 221 | — | — | — | — |
| 4 | 30 | 466 | 4 | 116.5 | B-2 | 1947 | 6 | 324.5 | — | — | — | — |
| 5 | 30 | 466 | 4 | 116.5 | B-2 | 1947 | 6 | 324.5 | — | — | — | — |
| 6 | 30 | 466 | 4 | 116.5 | B-2 | 1947 | 6 | 324.5 | — | — | — | — |
| 7 | 40 | 764 | 6 | 127.3 | B-3 | 1000 | 2 | 500 | — | — | — | — |
| 8 | 40 | 764 | 6 | 127.3 | B-3 | 1000 | 2 | 500 | — | — | — | — |
| 9 | 40 | 764 | 6 | 127.3 | B-3 | 1000 | 2 | 500 | — | — | — | — |
| 10 | 30 | 466 | 4 | 116.5 | 39 | 442 | 2 | 221 | C-1 | 312 | 2 | 156 |
| 11 | 30 | 466 | 4 | 116.5 | 39 | 442 | 2 | 221 | — | — | — | — |
| 12 | 30 | 466 | 4 | 116.5 | 39 | 442 | 2 | 221 | — | — | — | — |
| 13 | 40 | 764 | 6 | 127.3 | B-2 | 1000 | 2 | 500 | — | — | — | — |
| 14 | 40 | 764 | 6 | 127.3 | B-2 | 1000 | 2 | 500 | — | — | — | — |
| 15 | no protective layer | | | | | | | | | | | |
| 16 | 30 | 466 | 4 | 116.5 | 40 | 764 | 6 | 127.3 | — | — | — | — |
| 17 | 7 | 547 | 6 | 91.2 | B-2 | 1000 | 2 | 500 | — | — | — | — |

*1: Electrophotographic Photoreceptor No.,
*2: Acryloyl Equivalent

TABLE 2

| | AC | | |
|---|---|---|---|
| Electrophotographic | Equivalent | Weight Ratio | Weight |
| Photoreceptor No. | Difference | A/B/C | Ratio |
| 1 | 104.5 | 1/9/0 | 0.111 |
| 2 | 104.5 | 3/7/0 | 0.428 |
| 3 | 104.5 | 6/4/0 | 1.5 |
| 4 | 208 | 1/9/0 | 0.111 |
| 5 | 208 | 3/7/0 | 0.428 |
| 6 | 208 | 6/4/0 | 1.5 |
| 7 | 372.6 | 1/9/0 | 0.111 |
| 8 | 372.6 | 3/7/0 | 0.428 |
| 9 | 372.6 | 6/4/0 | 1.5 |
| 10 | 104.5 | 3/6/1 | 0.5 |
| 11 | 104.5 | 0.5/9.5/0 | 0.0526 |
| 12 | 104.5 | 6.5/3.5/0 | 1.857 |
| 13 | 372.6 | 0.9/9.1/0 | 0.0989 |
| 14 | 372.6 | 6.5/3.5/0 | 1.857 |
| 15 | no protective layer | | |
| 16 | 10.8 | 3/7/0 | 0.428 |
| 17 | 408.8 | 2/8/0 | 0.25 |

Ac Based compounds 7, 30, 39, and 40 in Table 1 are each the above exemplified compounds.

B-2: KAYARAD DPCA120 (hexaacrylate of hexafunctional dipentaerythritol derivative, of a molecular weight of 1947, produced by Kippon Kayaku Co., Ltd.)

B-3E8402 (bifunctional urethane acrylate of a molecular weight of 1,000, produced by Daicel-Cytec Co., Ltd.)

C-1 KAYARAD MANDA (bifunctional monomer of a molecular weight of 312, produced by Nippon Kayaku Co., Ltd.)

### (Evaluation)

Each of the electrophotographic photoreceptors listed in Table 1 was mounted on MAGIC COLOR 5430 (Konica Minolta Business Technologies, Inc.), and the following evaluation items were evaluated.

### (Image Blurring)

At an ambience of temperature/humidity of 30° C./85%, 5% printing images were continually printed onto 10,000 sheets. After turning off the power source, the printer was allowed to stand at the above ambience for 12 hours. After 12 hours, the printer was turned on, and image blurring was evaluated.
A: no image blurring was noted
B: negligible image blurring occurred
C: slight image blurring occurred but was at a commercially viable level
D: image blurring occurred often and was at a commercially unviable level

### (Photoreceptor Scraping (Abrasion Degree))

After printing the above 10,000 sheets, the thickness of the photoreceptor prior to and after printing was determined, and the abrasion degree of the photoreceptor was determined.

TABLE 3

| | | Photoreceptor |
|---|---|---|
| Electrophotographic | Image | Abrasion |
| Photoreceptor No. | Blurring | Degree (μm) |
| 1 | A | 0.8 |
| 2 | A | 0.3 |
| 3 | B | 0.15 |
| 4 | B | 1.7 |
| 5 | B | 0.9 |
| 6 | B | 0.7 |
| 7 | A | 1.9 |
| 8 | A | 1 |
| 9 | B | 0.7 |
| 10 | A | 0.4 |
| 11 | B | 3.2 |
| 12 | D | 0.1 |
| 13 | A | 4 |
| 14 | D | 0.2 |
| 15 | B | 3 |
| 16 | D | 0.24 |
| 17 | C | 2.9 |

As can be seen from Table 3, electrophotographic photoreceptors of the present invention resulted in good evaluation of image blurring and low photoreceptor abrasion. On the other hand, comparative electrophotographic photoreceptors resulted in no better evaluation of both criteria.

1. An electrophotographic photoreceptor comprising an electrically conductive support having thereon a photosensitive layer and a protective layer in that order,
wherein the protective layer comprises a resin which is prepared by allowing at least two acrylic or methacrylic compounds to react, and
one of the acrylic or methacrylic compounds is a minimum acryloyl equivalent compound having a minimum acryloyl equivalent and another of the acrylic or methacrylic compounds is a maximum acryloyl equivalent compound having a maximum acryloyl equivalent, the minimum acryloyl equivalent being different from the maximum acryloyl equivalent, and
relationships 1) and 2) are satisfied;
100≦maximum acryloyl equivalent−minimum acryloyl equivalent≦400 1)
0.1≦weight of minimum acryloyl equivalent compound/weight of maximum acryloyl equivalent compound≦1.6, 2)
wherein acryloyl equivalent of an acrylic or methacrylic compound is
(molecular weight of the acrylic or methacrylic compound)/(number of acryloyl or acryloyl groups of the acrylic or methacrylic compound).

2. The electrophotographic photoreceptor of claim 1, wherein the relationships 2′) is satisfied;
0.1≦weight of minimum acryloyl equivalent compound/weight of maximum acryloyl equivalent compound≦0.5. 2′)

3. The electrophotographic photoreceptor of claim 1, wherein the number of acryloyl or methacryloyl groups of the minimum acryloyl equivalent compound is at least 4.

4. The electrophotographic photoreceptor of claim 1, wherein the number of acryloyl or methacryloyl groups of the maximum acryloyl equivalent compound is 2.

5. The electrophotographic photoreceptor of claim 1, wherein the protective layer has a thickness of 0.2-10 μm.

6. The electrophotographic photoreceptor of claim 1, wherein the protective layer has a thickness of 0.5-6 μm.

7. The electrophotographic photoreceptor of claim 1, wherein the protective layer contains a filler.

8. The electrophotographic photoreceptor of claim 1, wherein the protective layer contains a lubricant.

9. The electrophotographic photoreceptor of claim 8, wherein the lubricant is fluorine containing resin particles.

10. The electrophotographic photoreceptor of claim 1, further comprising an inter layer between the electrically conductive support and the photosensitive layer.

11. The electrophotographic photoreceptor of claim 1, wherein the inter layer is composed of a polyamide resin.

12. The electrophotographic photoreceptor of claim 1, wherein the inter layer has a thickness of 0.1-15 μm.

13. The electrophotographic photoreceptor of claim 1, wherein the photosensitive layer comprises a charge generating layer and a charge transporting layer.

14. A method for preparing an electrophotographic photoreceptor of claim 1, comprising steps of;
forming a photosensitive layer on an electrically conductive support, and
coating a composition containing at least two acrylic or methacrylic compounds dissolved in a solvent on the photosensitive layer, and exposing the coated composition to actinic radiation to form a protective layer,
wherein one of the acrylic or methacrylic compounds is a minimum acryloyl equivalent compound having a minimum acryloyl equivalent and another of the acrylic or methacrylic compounds is a maximum acryloyl equivalent compound having a maximum acryloyl equivalent, the minimum acryloyl equivalent being different from the maximum acryloyl equivalent, and
relationships 1) and 2) are satisfied;
100≦maximum acryloyl equivalent−minimum acryloyl equivalent≦400 1)
0.1≦weight of minimum acryloyl equivalent compound/weight of maximum acryloyl equivalent compound≦1.6, 2)
wherein acryloyl equivalent of an acrylic or methacrylic compound is
(molecular weight of the acrylic or methacrylic compound)/(number of acryloyl or acryloyl groups of the acrylic or methacrylic compound).

15. The method of claim 14, wherein the coating composition further contains a radical polymerization initiator.

16. The method of claim 11, wherein the radical polymerization initiator is a photopolymerization initiator or thermal polymerization initiator.

17. The method of claim 11, wherein an amount of the radical polymerization initiator is 0.1-20% by weight with respect to the total weight of the (meth)acrylic compounds.

18. The method of claim 13, wherein an amount of the radical polymerization initiator is 0.5-10% by weight with respect to the total weight of the (meth)acrylic compounds.

19. The method of claim 12, wherein the steps further comprises drying between the steps of coating and exposing.
